(19) United States
(12) Patent Application Publication
(10) Pub. No.: US 2016/0357370 A1
(43) Pub. Date: Dec. 8, 2016

(54) SYSTEM AND METHODS FOR ORGANIZING AND MAPPING EVENTS AND OBJECTS AT A GEOGRAPHIC AREA

(71) Applicant: Napa Jet Center, Napa, CA (US)

(72) Inventors: Mark Willey, Napa, CA (US); Warren Coykendall, Vallejo, CA (US)

(21) Appl. No.: 15/174,828

(22) Filed: Jun. 6, 2016

Related U.S. Application Data
(60) Provisional application No. 62/170,857, filed on Jun. 4, 2015.

(51) Int. Cl. G06F 3/0482; G06F 17/30; G06Q 10/06; G06Q 50/30; G06F 3/0484; G06Q 30/00

(52) U.S. Cl. CPC G06F 3/0482; G06F 3/04845; G06Q 30/016; G06Q 10/063114; G06Q 50/30; G06F 17/30241

(57) ABSTRACT

Systems and methods are used to organize and manage objects in a geographic area. A representation of the geographic area is displayed on a user display. A representation of an object is superimposed on the geographic area on the display. Information about the object is represented or coded through the display of the object.

### PRIORITY

This application claims priority to U.S. Application No. 62/170,857, filed Jun. 4, 2015, which is incorporated by reference in its entirety into this application.

### BACKGROUND

Conventionally, air fields can manage objects and events in their space by personally witnessing multiple events as they are observed or requested. For example, the locations of airplanes may be visually seen as planes are parked, while requests for services on a plane (e.g. refueling, catering, etc.) may be sent to a customer service representative of the air field. This information may be kept by one or more people at the air field.

Typically, a plane is scheduled to arrive at a given time at the air field. The plane arrives and parks somewhere at the airfield. The plane attendant may request services for the plane when submitting its flight plan or after the plane has arrived. The customer service of the air field then fulfills the requested services. However, when it comes time to fill services or know whether a plane has been serviced, the plane must be located out on the airfield, and the records need to be confirmed back at some office. The process is inefficient and requires multiple personnel to handle and coordinate single events.

### BRIEF SUMMARY

Embodiments described herein may be used to coordinate the events at a geographic location, including tracking locations, objects, events, status, etc. Embodiments may comprise a user interface to one or more databases or systems in which one or more users can enter information, such as arrival and departure times, identification, requests, notes, payment, etc. The user interface may include a map or other visual representation of a geographic location. The user interface may include one or more symbols to represent objects within the geographic location. The one or more symbols may provide information to the user, such as by displaying one or more pieces of data entered through the user interface or retrieved from the one or more databases or systems in which the user interface communicates with. The user interface may permit a user to search, filter, sort, or otherwise retrieve, view, and/or manipulate the data either directly entered and/or retrieved through one or more of the connected databases/systems. Embodiments described herein may include any combination of features provided in the exemplary embodiments.

### DRAWINGS

FIG. 1 illustrates an exemplary user interface according to embodiments described herein.

FIG. 2 illustrates a close up of the exemplary user interface of FIG. 1.

FIGS. 3A and 3B illustrate exemplary user interface according to embodiments described herein.

FIG. 4 illustrates an exemplary user interface according to embodiments described herein.

FIG. 5 illustrates an exemplary network to support the exemplary user interface described herein.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

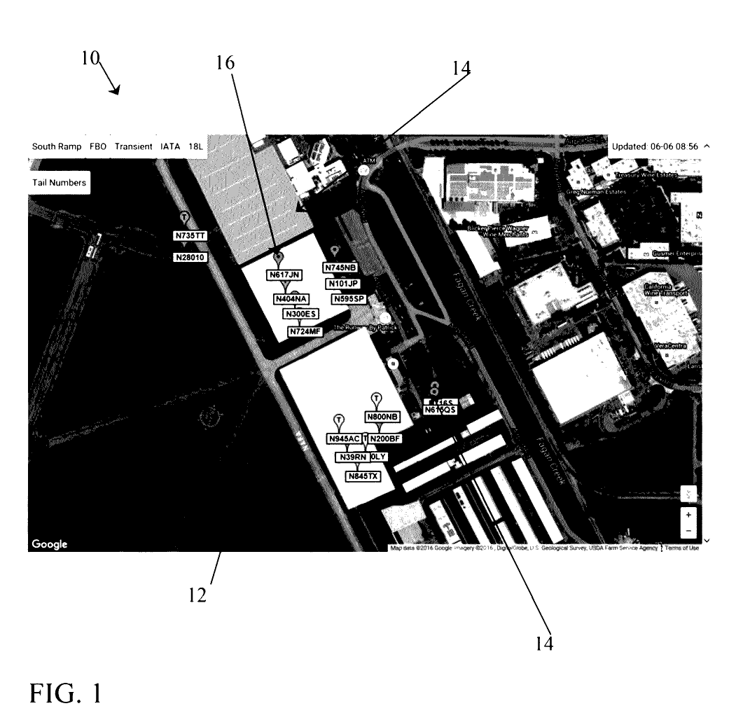

FIG. 1 illustrates an exemplary user interface according to embodiments described herein. The user interface 10 depicts a geographic location 12. For example, the user interface 10 may show a representation of a geographic location 12, such as a map or aerial image. The geographic location 12 may be represented in a written form using shapes, symbols, and words to correspond to features of the geometric location. Alternatively or in addition thereto, the geographic location 12 may be an actual or approximate image or picture of the geographic location, such as from aerial or satellite photography. For the airfield exemplary embodiment, geographic features such as run ways, air fields, parking lots, buildings, hangers, natural or semi-natural space, may be represented in visual form on a display.

The representation of the geographic location may include additional features added or altered by a user. For example, the exemplary user interface may include one or more overlays 14 in which part of the geographic location is overlaid with another image or object. The user interface may also include one or more symbols representing objects, locations, events, and combinations thereof occurring at the geographic location. The representative symbols of objects may display information about the object, event, or location. The user interface may display the information in text, symbols, color codes, alphanumeric characters, and combinations thereof in short or detailed versions. An overlay is not intended to require a separate physical layer on the display. Instead, the overlay 14 is a visual alteration of the base representation of the geographic location 10.

For example, as seen in FIG. 1, an overlay 14 may permit a user to select one or regions of the represented geographic location and identify information associate with the region. The information may be color coded, textual, labels, symbols, patterned, etc. As shown in FIG. 1, different regions of the airfield are color coded. The overlay 14 may be opaque and be presented over the representation of the geographic area. The overlay 14 may also be opaque, semi-opaque, or transparent such that the overlay 14 integrates into the representation of the geographic region 12. For example, the underlying geographic area may be seen through the overlay, but the color tinted; texture altered; labels, boarders, symbols, or other representations are present to provide information to the user about the area not present in the visual appearance of the geographic location itself.

Exemplary overlay 14 may also include representations of objects 16. In this case, a different combination of text, symbols, color codes, alphanumeric characters, and combinations thereof may be used to distinguish objects from geographic region designations. Representations of objects 16 may include a combination to identify the object and provide additional information about the object.

The geographic representation may include scaling, panning, zooming, or other manipulation abilities to reposition, reorient, or otherwise relocate the geographic representation on an area of interest. For example, a drop down menu may be provided that indicates various sub-locations within the represented geographic location. Choosing a sub-location may then re-center on a display the geographic location and/or zoom the geographic location on or around the chosen sub-location. Text entry or drop down box or other input may be used to zoom an image. Panning selections or drag and drop options may be used to reposition the geographic representation as desired.

FIG. 1 illustrates an exemplary embodiment according to the description hereof in which the represented geographic location 12 is an airfield. The image of the air field may be from a satellite image, map, or other aerial representation. The image may also include one or more overlays 14 in which designated areas of the geographic area image are covered with another image. As shown, three areas are overlaid in different colored geometric shapes. These shapes correspond to portions of the airfield. Objects on the airfield, such as, for example, planes and buildings are represented by symbols positioned on the geographic image and/or overlaid image. As shown, the symbols include pinpoints, but may include any symbol either related or unrelated to the actual object represented. For example, planes can include one symbol, such as a plane form or simplistic representation with wings, while buildings may include a different symbol, such as a simplistic house representation, squares, etc. The symbols may be detailed or simple renderings associated with the different objects. Therefore, the symbols may be the same or different depending on the object, location, and/or event being represented.

The overlay may be coded such that different information associated with the object or region can be displayed through or with the symbol. For example, a color code may be used to indicate a first set of information associated with the object or region; a symbol code may be used to indicate a second set of information; an alphanumeric code may be used to indicate a third set of information. Any combination of codes may be used to represent and combination of desired information. The user interface may also be programmed to define the selected combinations of representations for the different combination of information sets, and/or select which combinations of information sets are displayed.

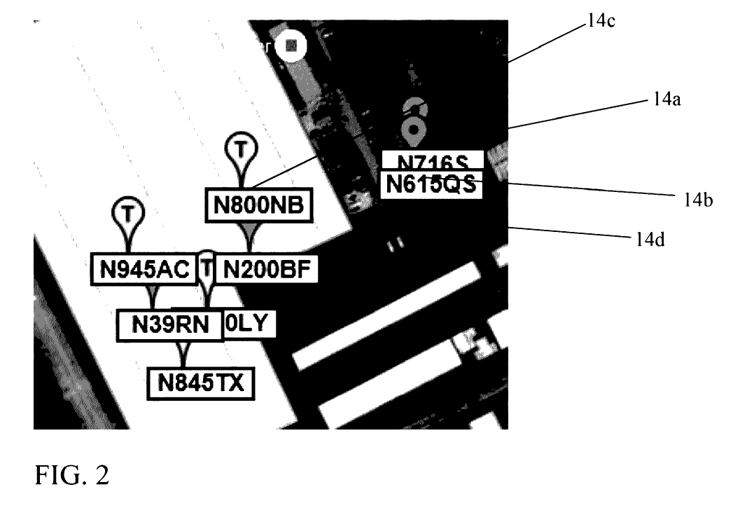

As shown, a first symbol code is used to represent objects in the geographic area. For example, as illustrated in FIG. 2, the first set of information identifies the type of object and is represented by a first set of symbols 14a. As shown, each of the represented objects of the same type corresponds to the same symbol (the pinpoint for an airplane). However, different objects may use different symbols. For example, the planes may be represented with a first symbol, while buildings may be represented with a second symbol. The symbols may be related or represent the associated object or may be unrelated. In addition or alternatively thereto, a second set of information identifies the object status or state and is represented by a first set of color codes 14b. For example, yellow may indicate an airplane on approach or expected to arrive, but not yet on the ground; green may be on the ground and fully serviced or without service requests or ready to depart; red may indicate an outstanding service request such as fueling or catering. Different colors may indicate different outstanding requests such as red for fuel and orange for catering. Textures or patterns may also be used instead of or in conjunction with the color coding or other coding system to represent additional information about the object, such a red cross hatch may indicate fueling, while a red solid fill may indicate catering. The color code may also be used in conjunction with a second symbol code 14c to correlate a condition of the object. For example, a dot (or other symbol such as x or L) may indicate that the associated plane is locked and cannot be moved, while a circle (or other symbol such as T or check) may indicate tow ready and can be moved from its current location if necessary. The symbols or characters may be used with different shades of the color coding to further highlight or distinguish the associated condition of the object. An Alphanumeric code 14d may also be associated with the depicted object to name and/or individually identify the object. For example, a name, such as conf. A, or the N462W may be used distinguish or identify the objects. Exemplary names or identifiers could include a plane's tail number.

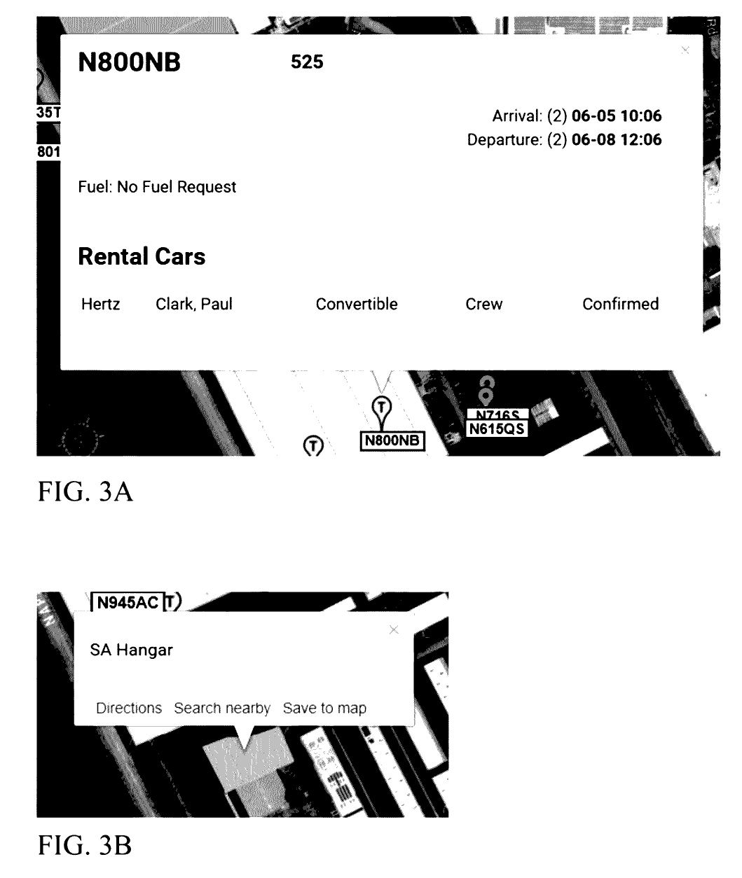

The user interface may also be used to display additional information associated with a represented objected. For example, if a user clicks on or hovers over a representative object, additional information about that object may be provided. FIGS. 3A and 3B illustrates an exemplary user interface displaying additional or expanded information about an object. The associated additional information window may display different information depending on the associated object which it relates. For example, as seen in FIG. 3A, the expanded information associated with an airplane may include the identifier, the expected arrival and departure times, and the related services, such as fueling requests, ground transportation requests, catering, etc., and associated statuses. As seen in FIG. 3B, the expanded information associated with a building identifies the building, permits the user to link to other systems, such as maps, etc., and may provide reservation or event information, etc.

As shown, the expanded information may include information about the object, such as its alphanumeric identifier 14d (e.g. tail number), arrival and departure information, requests (such as fuel or catering), other services (such as rental car or other transportation), owner or associated persons, associated locations (if it has an assigned hanger or parking location), or other notes. The expanded information may be displayed when a user clicks on the associated object symbol and may be closed by clicking on a select portion (such as the x) on the expanded window. The expanded information may also be displayed when a user hovers over the symbol and may be removed when the user moves off the symbol.

The user interface may include one or more user interface features to manipulate the displayed image. For example, drop downs, text boxes, radio button selection options, etc. may be used to permit a user to filter, sort, find, or otherwise identify objects, events, locations, or features on the displayed geographic area. The user may search based on any combination of information associated with an object. For example, the user interface may display representations of all objects with a selected status or request (such as those requiring fueling or catering), with a selected condition (such as movable or tow ready), with a selected identifier (such as a tail number), other parameter (such as expected arrival or departure times or time frames), or any combination thereof.

The user interface may also be configured to communicate with outside systems to update the user interface accordingly. For example, the user interface may communicate with other database systems to retrieve information, such as service requests, object status, expected arrival and departure times, etc. The system may also communicate with remote input devices that permit a user to update the user interface of the system according to actions at a remote location. For example, a user may view the user interface on a mobile device. The user may select a representation of a given object on the user interface. The user interface may permit a user to update, alter, or modify one or more attributes or associated information of the represented object. The user may be presented with a user interface menu that permits the user to input the desired information. For example, the user may be able to update a status of a fueling request from the request being not started; to pending, being performed, or in process; to being completed. The user may send the updated information from the mobile device wirelessly to updated the system and the corresponding user interfaces of other user's connected to the system.

In an exemplary embodiment, the system may permit a user to update the system in transitional steps, or recognize whether transitional steps are being used. For example, if the system receives an image of an aircraft, but its location correspond to the same location, then the system may determine that an action is about to begin. The system may receive a second input, such as another image, text input, or selection from the user to determine the action. The system may update the user interface by identifying the action is in progress. The system may receive another image, such as the aircraft again, but associated with a new location. The system may therefore determine the relocation of the aircraft and updated the system as having been relocated. Similarly, the system may receive before and after images of fueling and determine that the aircraft is being refueled or has completed the refueling action.

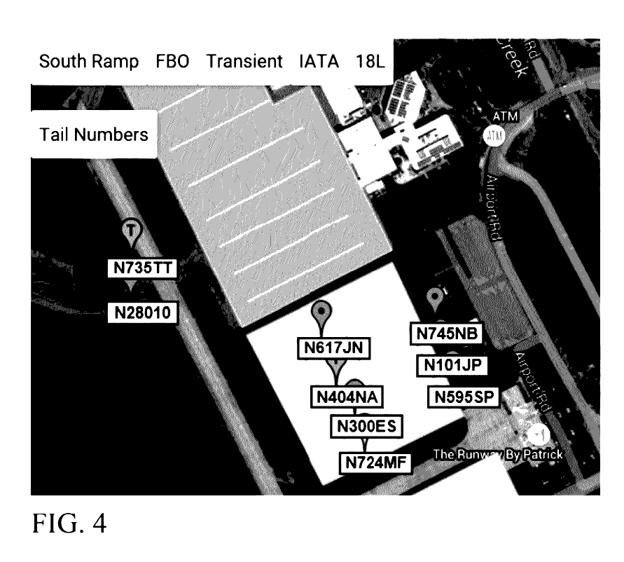

FIG. 4 illustrates an exemplary drop down that lists the identifiers of all of the represented objects on the displayed geographic area. As shown, the drop down includes the tail number of associated airplanes. The drop down may correspond to one or more associated, represented, or displayed information displayed by the above described codes. For example, the alphanumeric identifier may be displayed associated with an object symbol, and the alphanumeric identifier may be used as a drop down selection to find the specific object. Once selected or entered, the user interface may alter the symbol associated with the selected individual representation of the desired object, or may remove from the display all objects not meeting the selected criteria. For example, if a single object is identified, the symbol associated with that object may change color, size, shape or symbols, brightness, or other change in alternative or combination; the other objects corresponding to symbols representing objects not within the desired or identified one or more objects may similarly change color, size, shape, brightness, opaqueness, or other visual effect, and combinations thereof. For example, unselected objects may become more transparent, smaller, darker or more muted in color, or may be removed from the screen altogether; while symbols of the selected objects may become larger, brighter, highlighted, bolded, underlined, etc. The desired objects may also be indicated in other ways, such as by opening the associated expanded information displays of the selected group of objects.

In an exemplary embodiment, the system is configured to update a user interface by receiving information from an electronic device. In an exemplary embodiment, the update may use imaging technology along with imaging recognition and/or other received information, such as location information, to provide updates to the system. An exemplary embodiment, the system includes an electronic mobile device having a display, location information, such as from GPS, a camera, and combinations thereof. The system may receive an image from the camera, a location from the GPS, and an indication of an action from the input display to update the system, and combinations thereof. For example, the system may update the user interface by updated information associated with object on the user interface and/or updating the overlay corresponding to objects on the user interface after receiving image, location, and/or command information from the electronic device. The electronic device may be configured to interpret the information and send update information to the system or the electronic device may be configured to send retrieved information for interpretation by the system.

In an exemplary embodiment, the system may retrieve location information along with image information to update the system. A user may image an object by taking a picture. The system may retrieve the image and the associated location of the image and optically recognize features of the image to update the system. For example, the system may receive an image of an aircraft. The system may determine the object to be an aircraft and receive its

location information from the GPS coordinate of the mobile device taking the object image. The system may also use other locating information, such as direction, to distinguish multiple objects in close proximity to the mobile device used to retrieve the image. The system may also determine other information from the object, such as by using OCR or other optical recognition to determine other information about the object, such as, for example, the tail number of the aircraft. The system may then update the overlay corresponding to the represented object based on the received image. The system may be configured to respond differently depending on the received image. For example, if an image of the aircraft is received then the system may recognize that it is receiving location information about the aircraft and that the location information is retrieved and used to update the corresponding represented object with respect to the represented geographic region. If other objects are recognized, then the system may determine other actions are occurring. For example, if an image of a fuel gauge is detected, then the status of the object as being refueled may be updated, or if an image of a catering cart or food is retrieved, then the status of being restocked with food may be updated. The specific contents may be imaged, recognized, and cataloged as well for inventory, or invoicing. For example, the amount of different foods stuffs imaged may be used to identify, track, or invoice the aircraft of the service provided. The identity and amount may also be used for to track inventor of the airfield.

For example, an image of a fuel meter may be received from the camera. The image recognition software may recognize the fuel meter and retrieve a fuel amount from the meter. Another image may be retrieved of an identifier, such as of an airplane and/or its tail number. The system may recognize that an image of the meter indicates that it is responding to a fueling request and the image of the tail number indicates the associated object. The system may therefore update the status of the object associated with the tail number as needing fuel to being in the process of fueling. Another image of the meter from the same remote mobile device or with another image of the same tail number may indicate fueling is complete. The system may recognize the difference in the fuel meter readings and also determine a fuel amount. The system may, in addition thereto, or alternatively, also calculate, determine, or track other information, such as payment obligations associated with the fueling. The system may also use the imaging information in conjunction with other inputs. For example, once an image of the fuel meter is retrieved, the system may inquire through one or more user interface features, such as a pop-up window, to confirm the actions, such as refueling in progress, or refueling complete, and may permit a user to enter or select the object identifier. For example, the user may key in an identifier or may select the object, such as selecting the overlay corresponding to the object on the user interface or selecting an identifier of the object from a drop down menu. The system may also retrieve the location of the mobile device and camera from the GPS or other location system associated with the mobile device. The system may correlate the action to the objects in closest proximity to the mobile device at the time of image capture. For example, the objects may themselves be associated with real time or semi-real time location means, such as their own GPS or object tracking. The system may relate the camera image to a specific location and relate the image and corresponding action to the object in closest proximity to the image. The system may also provide a selection of object prioritized by proximity to the image location. The system may also use the last known location of an object instead of the real time or semi-real time location of an object.

Exemplary embodiments of the user interface may be generated from logic configured to perform functions to create the displays and features described herein. Such user interface logic is performed by a processor processing logic that may comprise hardware (circuitry, dedicated logic, state machines, etc.), software (such as is run on a general purpose computer system or a dedicated machine), or a combination of both, and displaying the results on a display to a user.

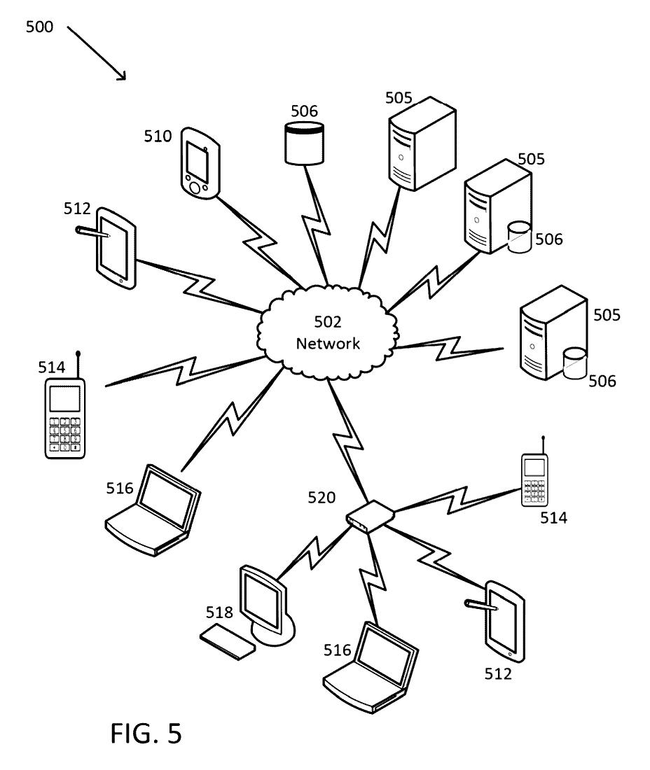

FIG. 5 illustrates an exemplary system 500 to support embodiments described herein. The user interface may be displayed on one or more combinations of laptop 516, desktop 518, smart phone 514, tablet 512, or other electronic mobile display 510. The system may communicate with a public network 502 and/or private network 520. The logic may be stored locally at one or more of the display devices or remotely at one or more servers 505 and databases 506, accessed over either the local or public network. Exemplary embodiments are configured to receive information at a first display device 510, 512, 514, 516, and/or 518 from a first user and update one or more other display devices 510, 512, 514, 516, and/or 518 remote from the first display device of a second user. The display devices may include input/output components to assist in inputting and outputting information to and from the system. For example, as described herein, a display device may include a camera for retrieving visual information about an object and after analyzing the image, update the system accordingly.

In an exemplary embodiment, the user interface logic includes features to generate a representation of a geographic location; permit a user to manipulate the display of the geographic location; permit a user to overlay images on the representation of the geographic location; search, filter, sort, or organize the information presented on the user interface; superimpose symbols or information onto the representation of the geographic location; reposition, modify, add, and remove the superimposed symbols or information displayed on the representation of the geographic location; interface with a user through input/output devices; interface with one or more database to retrieve information displayed on the representation of the geographic location; and combinations thereof.

In an exemplary embodiment, the user interface logic permits a user to alter the representation of the geographic location. The user may pan, zoom, reposition, rotate, or otherwise relocate or reconfigure the representation of the geographic location. The user interface logic may permit a user to enter or select a location on the representation of the geographic location. Such selection, such as by typing a name into a text box or selecting a location from a drop down, may be used to reposition and/or zoom the representation of the geographic area displayed on the user interface to the selected location.

In an exemplary embodiment, the user interface logic permits a user to find, filter, sort, or otherwise organize representations and/or information on the representation of the geographic area. For example, the user may enter in an identifier or select one or more information attributes about an object. The user interface logic then responds with a given output. For example, if the user selects to filter the displayed images, the user interface logic may permit the user to enter in one or more parameters such as by radio button selection, drop down menus, and/or text boxes. The user interface logic then displays only those representations of objects meeting the criteria, or otherwise changes the representations on the user interface in accordance with embodiments described herein (such as by changing relative sizes, transparency, color, symbols, etc. of objects inside or outside of the selected parameters).

In an exemplary embodiment, the user interface logic permits a user to enter information about an object and/or interfaces with one or more databases to retrieve information about an object represented on the representation of the geographic area. For example, the user interface may interface with scheduling or other software that is used to identify incoming and outgoing aircraft to and from the air field, with associated identifiers, estimates times of arrival and departure, and/or requested services. The user interface logic may interface with vendor services such as transportation services, or other on and off-sight services such that events can be coordinated from a central location around the represented object. The user interface may also permit a user to directly enter, modify, delete, or otherwise manipulate information through user input/output devices.

In an exemplary embodiment, the user interface logic retrieves information from a scheduling database that tracks identification information, arrival and departure information, service requests, and combinations thereof. The user interface logic then illustrates a symbol associated with an object at or near the indicated arrival time. For example, a designated period of time before arrival, the user interface logic may display a symbol associated with the object on the representation of the geographic area. In an exemplary embodiment, the symbol associated with an incoming object is displayed 1 hour, 45 minutes, 30 minutes, or 15 minutes before arrival. The time associated with displaying the object may be set or may be dynamic. The added symbol may be located on a given portion of the representation of the geographic area designated for incoming objects. The symbol may be selected or otherwise coded based on the status of expected arrival or not yet arrived. The user interface logic may automatically remove a symbol associated with an object from the display at or sometime after the expected departure time. The user interface logic may request confirmation before removing the symbol, or may automatically remove the symbol based on the time, and/or other confirmation provided through one or more other scheduling databases in communication with the user interface.

The user interface logic then permits a user to relocate the symbol associated with an object to desired locations on the representation of the geographic area. For example, a user my drag and drop the symbol associated with an object to depict its location at the geographic area. In an exemplary embodiment, a user may position representations of incoming aircraft at a run way intended to receive that aircraft, or a user may position already grounded aircraft at their location within a lot or hanger, etc. Thus, the user interface logic may permit manual manipulation of representations of objects displayed on the representation of the geographic area.

The user interface logic may automatically add, remove, position, or reposition representation of objects on the representation of the geographic area from information retrieved from one or more data sources or data bases. For example, in an exemplary embodiment, the user interface logic may interface with a radar, or other detection system to detect the approach of an aircraft. The user interface logic may then interface with the scheduling database to identify one or more expected incoming aircraft. The user interface logic may then present a list to the user to select information associated with the object or may permit the user to enter information associated with the object. The user interface logic may then represent the object on the representation of the geographic area in an approximate location as detected. The location may be tracked and updated as detected by the radar or other detection system. The user interface logic may similarly update the location of the associated object on the user interface display. The user interface logic may then relocate the object on the user interface display based on information entered or stored in the scheduling database. For example, once the aircraft is parked and the location identified to the scheduling software, the user interface logic may retrieve that information and position the representation of the object on the representation of the geographic area according to the information stored or entered into the scheduling database. The user interface logic may request user confirmation before making a change based on retrieved or entered information, or may automatically update the user interface display. Any of the information, representation, coding, etc. may similarly be updated based on user input, manually or automatically directly or from other systems communicating with the user interface. For example, once an aircraft has been serviced, the servicing information may be entered directly into the user interface or through the scheduling software, and the appropriate information, representation, and/or coding may be updated on the user interface display.

An exemplary embodiment includes a system for generating the user interface described herein. The system may include a set up module which permits a user to set up the system. The set up module may permit a user to identify a geographic area of interest. The geographic area of interest may be selected, for example, on a map display or may be entered by address information, location description, latitude/longitudinal ranges, parcel identifiers, or any combination thereof. Once the geographic area of interest is entered, the system may routinely update the image from public sources. The set up module may also be used to permit a user to overlay one or more images on top of the representation of the geographic image. For example, if a satellite image is retrieved for use as the representation of the geographic area, the set up module may permit a user to identify sub-locations on the image to overlay with geometric or freeform shapes. The overlay may identify desired locations such as parking lots, hangers, run ways, etc. The overlays may impose color coding, textures, or patterns to identify locations of interest. The overlay may be opaque or semi-transparent such that the underlying representation of the geographic area may or may not be seen through the overlaid image. The system may track the overlaid locations with respect to the representation of the geographic area such that if the representation of the geographic area is refreshed or moved, the overlaid images are positioned accordingly on the user interface to maintain the same relative location based on physical location represented by the geographic location. For example, as the geographic location is repositioned on the screen, the overlaid imaged can reposition accordingly to overlay on the same part of the geographic representation. The set up module may also permit a user to selected desired information to display either directly on the user interface or through one or more expanded information displays of the user interface. The set up module may also permit a user to select associated codes to represent different information. The set up module may also permit the user to create accounts, set up users, set access and restrictions (read v. read/write access), or set other system preferences and parameters.

The system may also include one or more communication modules. For example, the system may include multiple interfaces, such as displayed on mobile devices. The communication module may handle data entry, conflict resolution, and dissemination of the information to the one or more user interfaces across the one or more user displays. For example, a service provider may user the user interface at a first mobile device to search for aircraft requiring a specific outstanding service requirement. The first mobile device may also be used to enter information about aircraft status that have been serviced or have completed service. The communication module may then relay the information through the user interface and update other user interfaces on other displays. The communication module may also update information stored on databases in communication with the user interface. For example, a scheduling program may be updated based on services rendered, and then entered or confirmed complete through the user interface. Therefore, other service providers may know that status of a given aircraft in real-time or semi-real time without the necessity of relaying through other personnel.

Although embodiments of this invention have been described with reference to the accompanying drawings, it is to be noted that various changes and modifications will become apparent to those skilled in the art. Such changes and modifications are to be understood as being included within the scope of embodiments of this invention as defined by the appended claims.

Although embodiments of the invention may be described and illustrated herein in terms of airfield and airport geographic locations, it should be understood that embodiments of this invention are not so limited, but are additionally applicable to any geographic locations in which objects and/or events must be managed and coordinated.

The invention claimed is:

1. A user interface, comprising:
a representation of a geographical area of interest; and
a representation of one or more objects on the representation of the geographical area of interest, the representation of one or more objects including information about the one or more objects.

2. The user interface of claim 1, wherein the information included about the one or more objects is coded by color, shape, symbol, alphanumeric character(s), and a combination thereof

3. The user interface of claim 1, wherein the one or more objects comprise aircraft and the geographical area of interest comprises an air field.

4. The user interface of claim 3, wherein the information includes a tail number and a status of the aircraft.

5. The user interface of claim 4, wherein the status of the aircraft is not yet arrived, one the ground, departing, or a combination thereof.

6. The user interface of claim 4, wherein the information includes a condition of the aircraft.

7. The user interface of claim 6, wherein the condition is needing fuel, good, needing maintenance, needing catering, or a combination thereof.

8. The user interface of claim 6, further comprising user interface logic, wherein the logic is configured to allow a user to reposition the representation of the one or more objects on the representation of the geographic area of interest.

9. The user interface of claim 8, wherein the user interface logic is configured to interface with one or more databases.

10. The user interface of claim 9, wherein the one or more databases comprises a scheduling database that includes arrival time and departure time for identified aircraft.

11. The user interface of claim 10, wherein the user interface logic is configured to add a new representation of an object on the representation of the geographic area of interest a predetermined time period before the arrival time stored in the scheduling database.

12. The user interface of claim 11, wherein the user interface logic permits a user to modify the information associated with the representation of the one or more objects.

13. A method of organizing and managing objects in a geographic area, comprising:
displaying a representation of the geographic area on a display;
superimposing a representation of an object on the geographic area on the display; and
representing information about the object through the representation of the object on the display.

14. The method of claim 13, wherein the representing information comprising using color, symbol, alphanumeric, texture, pattern, or a combination thereof coding to represent information about the object.

15. The method of claim 14, wherein the information includes a tail number and a status of the aircraft.

16. The method of claim 15, wherein the information includes a condition of the aircraft.

17. The method of claim 16, further comprising allowing a user to reposition the representation of the one or more objects on the representation of the geographic area of interest.

18. The method of claim 17, further comprising adding a new representation of an object on the representation of the geographic area of interest a predetermined time period before the arrival time stored and retrieved from a scheduling database.

19. The method of claim 18, further comprising modifying the information associated with the representation of the one or more objects.
